(19) United States
(12) Patent Application Publication
(10) Pub. No.: US 2021/0021659 A1
(43) Pub. Date: Jan. 21, 2021

(54) DELIVERY APPARATUS, DELIVERY METHOD, AND PROGRAM

(71) Applicant: SONY CORPORATION, Tokyo (JP)

(72) Inventors: Kazuhiko TAKABAYASHI, Tokyo (JP); Yasuaki YAMAGISHI, Kanagawa (JP); Mitsuhiro HIRABAYASHI, Tokyo (JP)

(73) Assignee: SONY CORPORATION, Tokyo (JP)

(21) Appl. No.: 17/043,233

(22) PCT Filed: Mar. 22, 2019
(86) PCT No.: PCT/JP2019/011986

§ 371 Date: Sep. 29, 2020

(30) Foreign Application Priority Data
Apr. 6, 2018 (JP) 2018-073808

(51) Int. Cl. H04L 29/06; H04N 21/845; H04N 21/239

(52) U.S. Cl. CPC H04L 65/601; H04N 21/239; H04N 21/8456

(57) ABSTRACT

There is provided a delivery apparatus, a delivery method, and a program that are capable of providing live delivery with lower delay. Based on a URL specified by a request from a client regarded as a destination to which a content is live-delivered by using MPEG-DASH, DASH segments included in content are delivered. An extended function of independently specifying a duration of DASH segments and a placement of an SAP is used to define the URL so as to make a request for a whole of a segment sequence including a series of DASH segments consecutively arranged. Further, the URL is defined so as to make a request for a predetermined number of DASH segments from a random access point, including a random-accessible DASH segment and subsequent DASH segments in the same segment sequence. The present technology is applicable, for example, to a content delivery system that provides live delivery by using MPEG-DASH.

### TECHNICAL FIELD

The present disclosure relates to a delivery apparatus, a delivery method, and a program, and more particularly, to a delivery apparatus, a delivery method, and a program that are capable of providing live delivery with lower delay.

### BACKGROUND ART

In the past, in contrast to on-demand delivery for delivering content pre-stored in a delivery server, live delivery (live streaming) for sequentially delivering content in accordance with a program (program guide), for example, of conventional TV broadcasting has been put to practical use. In live delivery provided, for example, by using MPEG-DASH (Dynamic Adaptive Streaming over HTTP), encoding, DASH segmentation, and MPD (Media Presentation Description) generation are conducted in real time. It should be noted that live delivery is not limited to live TV broadcasting.

For example, in Europe and the US, various live delivery services are provided as new services. TV broadcast content, which has been provided, for example, by terrestrial broadcasting, satellite broadcasting, cable broadcasting, and IP (Internet Protocol) broadcasting, is now widely provided by OTT (Over The Top) delivery (OTT Linear TV service).

However, when, for example, live delivery is provided by using MPEG-DASH or other adaptive delivery technique (e.g., HLS (HTTP Live Streaming)), transmission delay is presently significant in marked contrast, for example, to radio-wave broadcasting or IP broadcasting. Therefore, delay reduction is now demanded.

Under such circumstances, the MPEG-DASH standard is edited so that a scheme for reducing “theoretical delay” is incorporated in Amendment 4 of the 2nd edition issued in 2014, as disclosed in NPL 1.

### CITATION LIST

### Non Patent Literature

### [NPL 1]

Information technology—Dynamic adaptive streaming over HTTP (DASH)—Part 1: Media presentation description and segment for mats, AMENDMENT 4: Segment Independent SAP Signalling (SISSI), MPD chaining, MPD reset and other extensions

### SUMMARY

### Technical Problem

Meanwhile, efforts have been made in the past to reduce delay in live delivery by using MPEG-DASH as disclosed in NPL 1. From now on, however, it is anticipated that further delay reduction will be demanded.

The present disclosure, which has been made in view of the above circumstances, makes it possible to provide live delivery with lower delay.

### Solution to Problem

A delivery apparatus according to an aspect of the present disclosure includes a reception section and a delivery section. The reception section receives a request from a client regarded as a destination to which a content is live-delivered by using MPEG-DASH. The delivery section delivers DASH segments included in the content based on a URL specified by the request. In a case where an extended function of independently specifying a duration of the DASH segments and a placement of an SAP is used to define the URL so as to make a request for a whole of a segment sequence including a series of the DASH segments consecutively arranged, the delivery section delivers the whole of the segment sequence corresponding to the request.

A delivery method according to an aspect of the present disclosure includes the steps of, by a delivery apparatus providing live delivery by using MPEG-DASH, receiving a request from a client regarded as a destination to which a content is live-delivered, and delivering DASH segments included in the content based on a URL specified by the request. In a case where an extended function of independently specifying a duration of the DASH segments and the placement of an SAP is used to define the URL so as to make a request for a whole of a segment sequence including a series of the DASH segments consecutively arranged, the whole of the segment sequence corresponding to the request is delivered.

A program according to an aspect of the present disclosure causes a computer in a delivery apparatus providing live delivery by using MPEG-DASH to perform a process including the steps of receiving a request from a client regarded as a destination to which a content is live-delivered, and delivering DASH segments included in the content based on a URL specified by the request. In a case where an extended function of independently specifying a duration of the DASH segments and a placement of the SAP is used to define the URL so as to make a request for a whole of a segment sequence including a series of the DASH segments consecutively arranged, the program causes the computer to deliver the whole of the segment sequence corresponding to the request.

An aspect of the present disclosure receives a request from a client regarded as a destination to which a content is live-delivered by using MPEG-DASH, and delivers DASH segments included in the content based on a URL specified by the request. Further, in a case where an extended function of independently specifying a duration of the DASH segments and the placement of the SAP is used to define the URL so as to make a request for a whole of a segment sequence including a series of the DASH segments consecutively arranged, the whole of the segment sequence corresponding to the request is delivered.

### Advantageous Effect of Invention

An aspect of the present disclosure makes it possible to provide live delivery with lower delay.

It should be noted that advantages provided by the present disclosure are not necessarily limited to the above-described one. The present disclosure may provide any other advantages described herein.

### BRIEF DESCRIPTION OF DRAWINGS

FIG. 1 is a block diagram illustrating a configuration example of an embodiment of a content delivery system that provides live delivery by using MPEG-DASH.

FIG. 2 is a diagram illustrating a common MPD and a configuration of DASH segments.

FIG. 3 is a diagram illustrating a structure of a minimum-configured DASH segment.

FIG. 4 is a diagram illustrating an example of a DASH segment including a plurality of movie fragments.

FIG. 5 is a diagram illustrating an example of a <Period> element of DASH MPD.

FIG. 6 is a diagram illustrating an example of a segment sequence and DASH segments.

FIG. 7 is a diagram illustrating an example of an MPD and URLs.

FIG. 8 is a diagram illustrating an example of an MPD and URLs to which a new definition is applied.

FIG. 9 is a diagram illustrating an example of a URL for requesting a whole of a segment sequence and an example of URL requesting a predetermined number of DASH segments from a random access point.

FIG. 10 is a block diagram illustrating a configuration example of an embodiment of a delivery server and a DASH client to which the present technology is applied.

FIG. 11 is a flowchart illustrating a DASH segment delivery process performed by the delivery server.

FIG. 12 is a flowchart illustrating a DASH segment acquisition process performed by the DASH client.

FIG. 13 is a block diagram illustrating a configuration example of a computer to which the present technology is applied.

### DESCRIPTION OF EMBODIMENTS

Concrete embodiments to which the present technology is applied will now be described in detail with reference to the accompanying drawings.

### <Configuration Example of Content Delivery System>

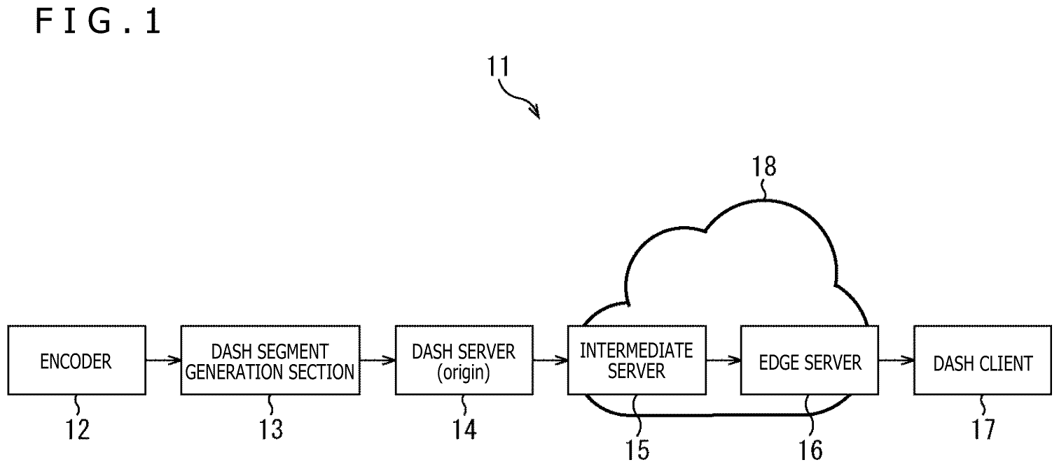

FIG. 1 is a block diagram illustrating a configuration example of an embodiment of a content delivery system that provides live delivery by using MPEG-DASH.

As depicted in FIG. 1, a live delivery system 11 configured to provide live delivery by using MPEG-DASH includes an encoder 12, a DASH segment generation section 13, a DASH server 14, an intermediate server 15, an edge server 16, and a DASH client 17. Further, the intermediate server 15 and the edge server 16 form a CDN (Content Delivery Network) 18 that delivers various types of content through the Internet.

The encoder 12 generates encoded data by encoding an image captured by an undepicted imaging apparatus, and supplies the encoded data to the DASH segment generation section 13. It should be noted that the encoder 12 may be substituted, for example, by a live feed reception section for receiving encoded data encoded by a content provider configured to perform live delivery. In such a case, the live feed reception section supplies the encoded data to the DASH segment generation section 13.

The DASH segment generation section 13 receives the encoded data supplied, for example, from the encoder 12 or the undepicted live feed reception section, generates DASH segments in real time from the encoded data, and supplies the DASH segments to the DASH server 14.

The DASH server 14 is an origin server that manages original DASH segments generated by the DASH segment generation section 13. The DASH server 14 supplies, to the intermediate server 15, DASH segments matching a request issued from the DASH client 17 through the intermediate server 15 and the edge server 16.

The intermediate server 15 is one of various servers included in the CDN 18 and used to relay the delivery of DASH segments from the DASH server 14 to the edge server 16.

The edge server 16 is one of various servers included in the CDN 18 and used to supply DASH segments directly to the DASH client 17.

The DASH client 17 receives DASH segments supplied from the edge server 16, acquires encoded data from the DASH segments, generates an image (live-delivered video) by encoding the encoded data, and displays the generated image on an undepicted display apparatus.

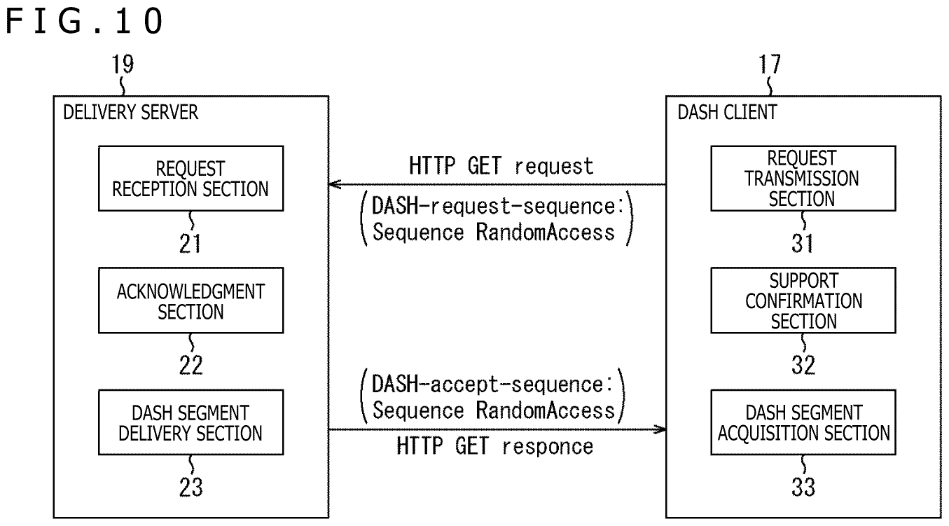

It should be noted that the a server performing a process of live-delivering the DASH segments to the DASH client 17, such as the DASH server 14, the intermediate server 15, or the edge server 16, is hereinafter referred, as appropriate, to also as a delivery server 19 (see FIG. 10).

The live delivery system 11 is configured as described above so that the URL (Uniform Resource Locator) of each DASH segment is presented to the DASH client 17 by an MPD (Media Presentation Description). The DASH client 17 then transmits an HTTP GET request for making a request for acquiring a desired DASH segment to a delivery server 19 (i.e., the DASH server 14 or the edge server 16).

Consequently, the live delivery system 11 is configured such that a DASH segment matching the HTTP GET request from the DASH client 17 is delivered to the DASH client 17 through the edge server 16. The live delivery system 11 has the above-described configuration, and is thus able to provide live delivery.

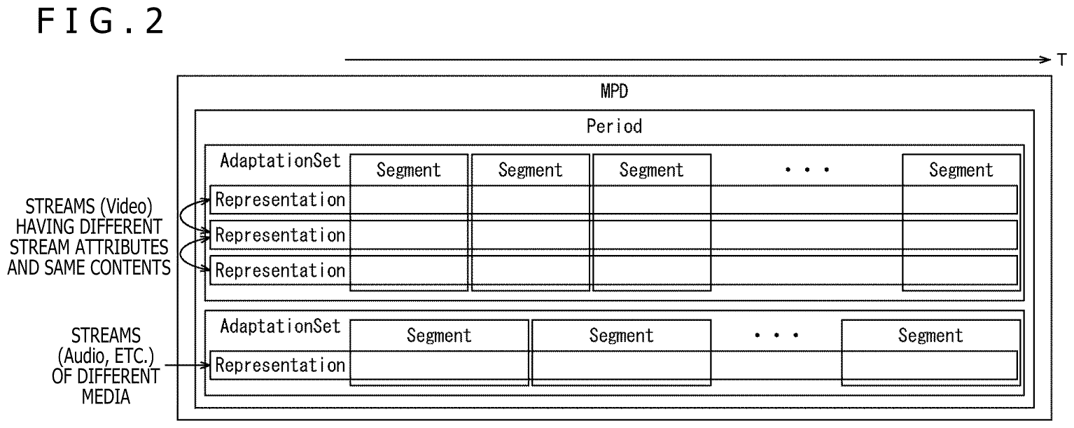

FIG. 2 illustrates a common MPD and a configuration of DASH segments.

As depicted in FIG. 2, there is a Period below the MPD. The Period indicates a time span. Under the Period, an AdaptationSet is disposed for each (elementary) stream such as Audio and Video, and the attribute of the AdaptationSet is described. Further, for each group of a plurality of streams differing in rate or other attribute, which are derived from identical (elementary) streams, for example, their respective rates are described in relation to separate Representations.

Consequently, by referring to the values of the rates described in the MPD, the DASH client 17 is able to select an optimal stream according to the status of a network environment where the DASH client 17 is disposed.

Further, each Representation in an AdaptationSet is generally divided into Segments on an individual time span basis. Then, among these Representations, a Segment of subsequent time can be selected (by switching), at the boundary between the Segments, from a Representation different from what has been reproduced.

Incidentally, in the case of live delivery where a DASH segment is generated in real time, the DASH segment having a predetermined duration cannot be supplied from the DASH server 14 to the DASH client 17 until the DASH segment is completely generated. Therefore, it is theoretically impossible to avoid a delay corresponding to the duration of the DASH segment. It should be noted that the URL of each DASH segment is presented to the DASH client 17 by the MPD (Media Presentation Description).

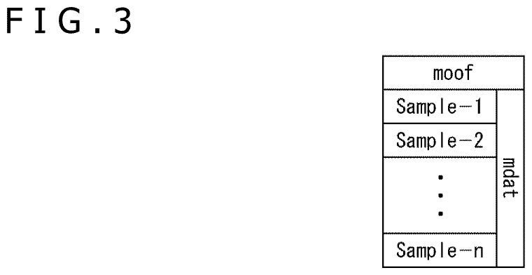

FIG. 3 illustrates a structure of a minimum-configured DASH segment.

Here, in the case of Video, each Sample included in a DASH segment is the data of each video frame. According to the operational profile of a conventional MPEG-DASH standard, a video frame classified as a Stream Access Point (SAP) type of 1 or 2 is at the beginning (Sample-1 in FIG. 3) of each DASH segment. This corresponds to what is generally called an Instantaneous Decoding Refresh (IDR) picture in the case of encoded video, such as AVC encoded or HEVC encoded video.

In view of the above circumstances, the live delivery system 11 is configured to be able to provide live delivery with lower delay while utilizing the scheme of SISSI disclosed in NPL 1, which is mentioned earlier.

For example, in live delivery provided by using MPEG-DASH, a length (duration) of a DASH segment needs to be reduced in order to reduce theoretical delay involved in DASH segment generation and delivery.

However, as mentioned above, it is demanded that the beginning of a DASH segment be operated as an SAP type of 1 or 2. Therefore, when the duration of one DASH segment is to be reduced in the case of encoded video, such as AVC encoded or HEVC encoded video, it is necessary to arrange IDR pictures at short intervals. As this results in a decrease in encoding efficiency (the ratio between resulting image quality and bit rate), the duration of one DASH segment cannot simply be reduced.

At present, “operational specifications” for providing low delay, for example, in DASH-IF (Industry Forum) and DVB (Digital Video Broadcasting) are discussed, and two different approaches described below are being studied.

A first approach is to perform a transfer on an individual movie fragment basis by means of HTTP chunked transfer coding while handling DASH segments as a plurality of movie fragments without changing the duration of the DASH segments.

A second approach is to reduce the duration of the DASH segments by using an extended function (SISSI) of the DASH standard.

Incidentally, the first approach does not usually change the duration of DASH segments when it is between several seconds and ten seconds. However, when the first approach is used, a plurality of movie fragments (pairs of “moof” box and “mdat” box) having a short duration is disposed in the DASH segments. Then, chunked transfer coding (transfer-encoding: chunked header specified) of HTTP is used on an individual movie fragment basis for the purpose of making it possible to supply the DASH segments to a client before the DASH segments are completely generated.

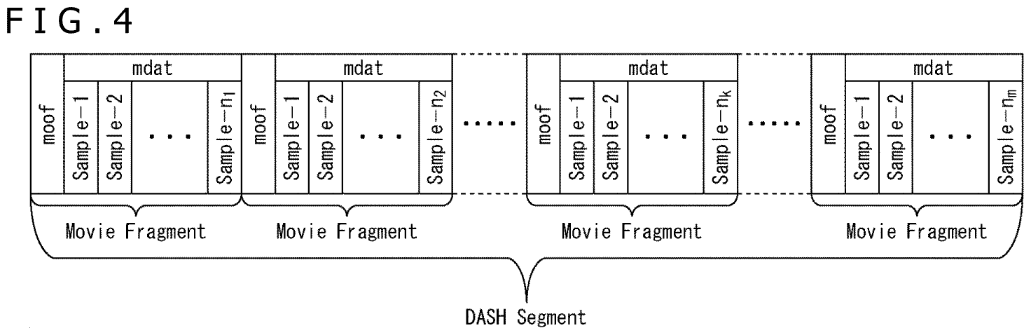

FIG. 4 illustrates an example of a DASH segment including a plurality of movie fragments.

In the DASH segment configured as depicted in FIG. 4, only Sample-1 of the first movie fragment needs to be an SAP (type 1 or 2). It does not matter whether or not Sample-1 of the other movie fragments is an SAP.

Using the DASH segment configured as depicted in FIG. 4 makes it possible to sequentially transfer data when movie fragments having a short duration are generated even if the DASH segment is still not wholly generated. More specifically, for example, it is possible to transfer data to the DASH server 14 from the DASH segment generation section 13 depicted in FIG. 1 and transfer data from the DASH server 14 to the DASH client 17, for instance, through the intermediate server 15 and the edge server 16.

In the above case, the DASH client 17 transmits an HTTP GET request on an individual DASH segment basis, and receives a response to the transmitted request on an individual movie fragment basis by means of chunked transfer coding. In such a manner, data can be transferred from the DASH server 14 to the DASH client 17 without waiting for complete generation of the whole DASH segment. This results in the reduction of theoretical delay.

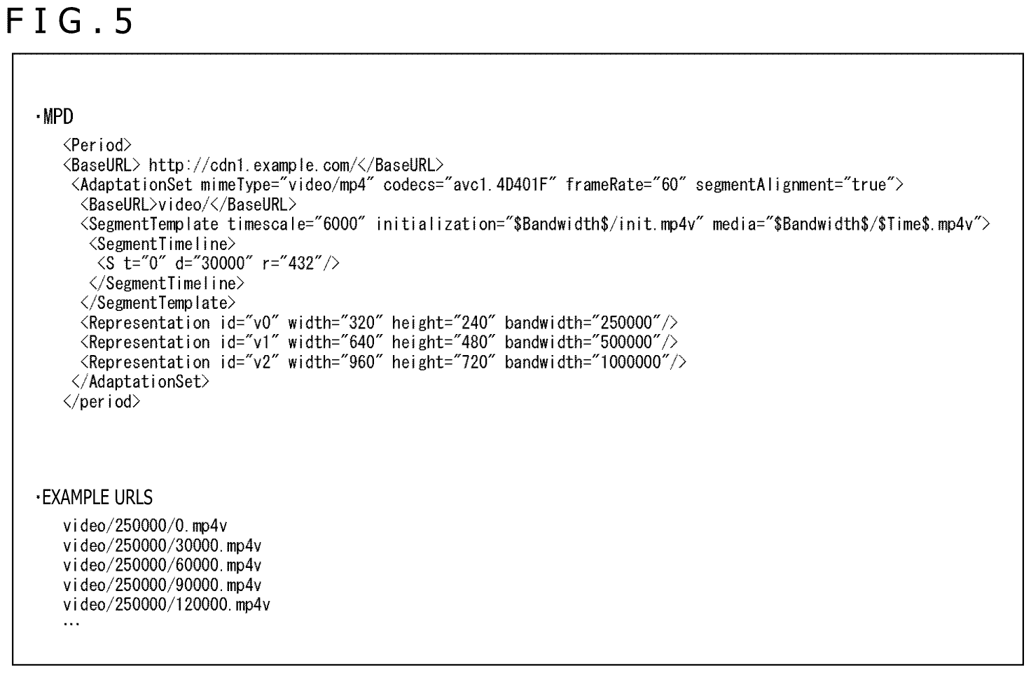

FIG. 5 illustrates an example of a <Period> element of DASH MPD in the above case.

However, when the above method is used, the DASH client 17 is merely able to make a request on the basis of individual DASH segments having a certain duration. Therefore, it is necessary to wait for a while until the beginning of the next DASH segment, for example, in a case where an attempt is made to newly start receiving live delivery at a time corresponding to the middle of a DASH segment or switch to different content (stream).

Under the above circumstances, Segment Independent SAP Signaling (SISSI) is introduced as an extended function conforming to the MPEG-DASH standard as described in the earlier-mentioned NPL 1. SISSI makes it possible to independently specify the duration of DASH segments and the placement of a Stream Access Point (SAP).

Accordingly, the second approach provides low delay by reducing the duration of each DASH segment through the use of the function of SISSI. More specifically, a series of consecutively arranged DASH segments corresponding to the DASH segment duration in the first approach is called a segment sequence, and movie fragments having a short duration are regarded as DASH segments.

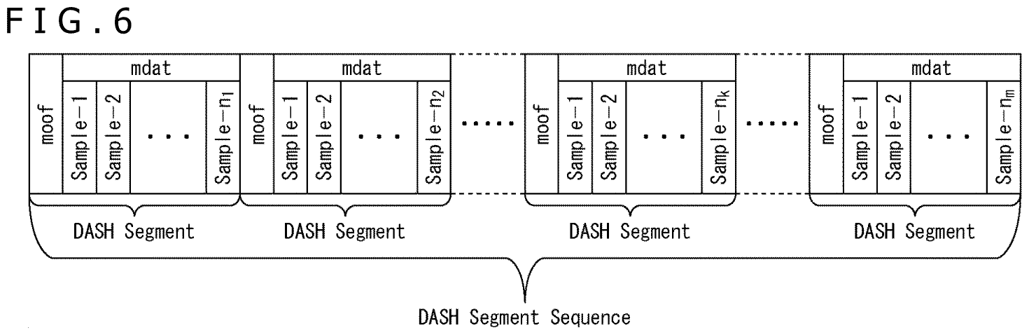

FIG. 6 illustrates an example of the segment sequence and DASH segments in the second approach.

As depicted in FIG. 6, the segment sequence includes a series of consecutive DASH segments. The segment sequence depicted in FIG. 6 corresponds to the DASH segment in FIG. 4, and the DASH segments in FIG. 6 correspond to the movie fragments in FIG. 4.

Further, in SISSI, a Switching element and a RandomAccess element are newly defined as child elements of AdaptationSet or Representation. Using these newly defined elements make it possible to indicate that the first Sample of a DASH segment is a DASH segment (Switching) classified as an SAP type of 1 or 2 or a random-accessible DASH segment (RandomAccess).

It should be noted that a random-accessible sample in the case of video may generally be the first I picture included in an open GOP (Group Of Pictures) in addition to a switchable sample (i.e., IDR picture). That is, the random-accessible sample is a sample such that all video frames displayed subsequently to the I picture can be correctly decoded and displayed when samples subsequent to the random-accessible sample are decoded.

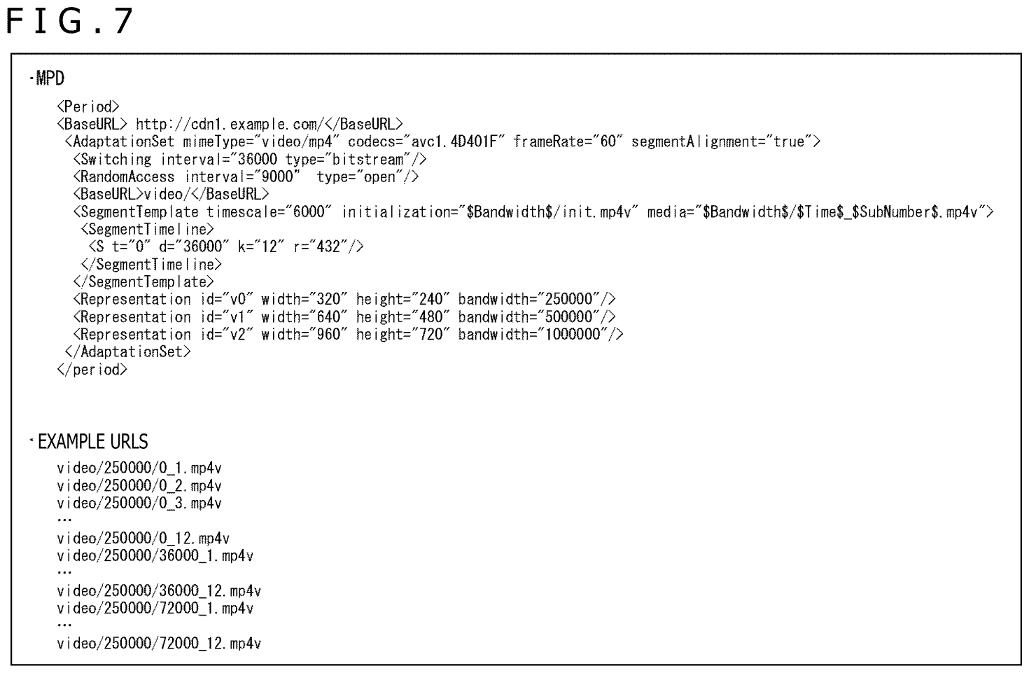

FIG. 7 illustrates an example of an MPD using a segment sequence and SISSI-defined elements and an example of URLs of DASH segments.

In FIG. 7, ‘<Switching interval=“36000”type=“bitstream”/>’ in the fourth line, ‘<RandomAccess interval=“9000” type=“open”/>’ in the fifth line, ‘$SubNumber$’ in the seventh line, and ‘k=“12”’ in the ninth line are newly added elements and attributes.

Further, in the examples of FIG. 7, the duration of a segment sequence is 6 seconds, and the duration of each DASH segment is 0.5 seconds. Here, the duration of the segment sequence is determined by dividing the value of S@d by the value of SegmentTemplate@timescale (6 seconds=36000/6000). Meanwhile, the duration of each DASH segment is determined by dividing the duration of the segment sequence by the value of S@k (0.5 seconds=6 seconds/12).

Here, FIG. 7 indicates that the value of Switching@interval is 36000 and equal to the duration of the segment sequence. It should be noted that the two values need not be equal according to the standard. Operations are normally performed in such a manner that the two values are equal. Further, FIG. 7 indicates that the value of RandomAccess@interval is 9000. It signifies that a random-accessible DASH segment exists at 1.5-second intervals, that is, every three DASH segments.

As a result, it is possible to reduce delivery delay caused by the generation and transfer of DASH segments.

Incidentally, in a case where the above-described segment sequence is used, the DASH client 17 issues an HTTP GET request at intervals as short as 0.5 seconds which is the duration of a DASH segment. However, operations for generating a movie frame=DASH segment for each video frame are being studied in order to reduce delivery delay to the minimum. In such a case, the overhead of a large number of HTTP requests and responses is not negligible.

As regards live delivery provided by using MPEG-DASH, operations for reducing delay theoretically caused by the generation of DASH segments are being studied as described above. However, the above-mentioned two different approaches need to be improved to solve the following problems.

When the first approach is used, the DASH client 17 is able to make a request on the basis of individual DASH segments having a relatively long duration. Therefore, it is necessary to wait for a while until, for example, the beginning of reception of live delivery or switching to a different live stream. Meanwhile, reducing the duration of DASH segments results in a decrease in encoding efficiency.

Using the second approach solves the problem in the first approach, which is having to wait for a while as described above. However, in a case where the delay is to be reduced to the minimum, a large number of HTTP requests and responses occur as compared to presently common live delivery. That is, the overhead of a large number of HTTP requests and responses is not negligible.

It should be noted that a server push function is prescribed as a new part (ISO/IEC 23009-6:2017) by the MPEG-DASH standard in order to avoid the overhead caused by the second approach. The server push function utilizes a new protocol (e.g., HTTP/2 or WebSocket) different from the HTTP/1.1 protocol which is widely used at present. However, in marked contrast to the presently widespread HTTP/1.1 protocol, such a new protocol cannot easily be introduced into all servers and clients included in the CDN 18.

Under the above circumstances, the present technology additionally defines a new property for DASH MPD, and controls the behavior of the DASH server 14 and the DASH client 17 according to the value of the additionally defined property. This eliminates the above-mentioned overhead of a large number of HTTP requests and responses which is caused by the second approach.

More specifically, the present technology newly proposes first to third definitions described below.

The first definition defines a URL that is used in conjunction with an SISSI extended function in order to request a whole of a segment sequence.

The second definition defines a URL for requesting a predetermined number of DASH segments from a random access point. The predetermined number of DASH segments include a random-accessible DASH segment and the subsequent DASH segments in the same segment sequence.

The third definition defines a flag indicating whether or not it is possible to respond to the request (first definition) for the whole of the segment sequence and a flag indicating whether or not it is possible to respond to the request (second definition) for a predetermined number of DASH segments from a random access point.

As regards the first definition, the URL for requesting the whole segment sequence can be defined by omitting the $SubNumber$ variable from the above-mentioned MPD (Period element) depicted in FIG. 7. An alternative is to set “0” as the value of the $SubNumber$ variable or use “−” to express the range of a starting number to the value of S@k of Segment Template, for example, in “1-12” form.

As regards the second definition, the URL pointing to a sequence including a random-accessible DASH segment and the subsequent DASH segments in the same segment sequence can be defined by adding “+” to the end of the URL for requesting a predetermined number of DASH segments from a random access point. Further, an alternative is to specify the SubNumber range, for example, in “1-12” form, as is the case with the first definition.

As regards the third definition, in order to indicate whether or not it is possible to request the whole of the segment sequence, @sequence is defined as a new attribute to be added to the SegmentTemplate element or the SegmentTimeline element. Then, in a case where the value of @sequence is “true,” it is possible to indicate to the DASH client 17 that it is possible to respond to the request for the whole segment sequence.

Similarly, as regards the third definition, @randomSeq is defined as an attribute of the SegmentTemplate element in order to indicate whether or not it is possible to request a predetermined number of DASH segments from a random access point. Then, in a case where the value of @randomSeq is “true,” it is possible to indicate to the DASH client 17 that it is possible to respond to the request for a sequence including a random-accessible DASH segment and the subsequent DASH segments in the same segment sequence.

Further, in order to indicate whether or not it is possible to request the whole segment sequence, for example, @sequence may be defined for the Switching element. Further, in order to indicate whether or not it is possible to request a predetermined number of DASH segments from a random access point, @randomSeq may be defined for the RandomAccess element. Then, in a case where the values of @sequence and @randomSeq are “true,” it is possible to indicate to the DASH client 17 that it is possible to respond to the respective requests.

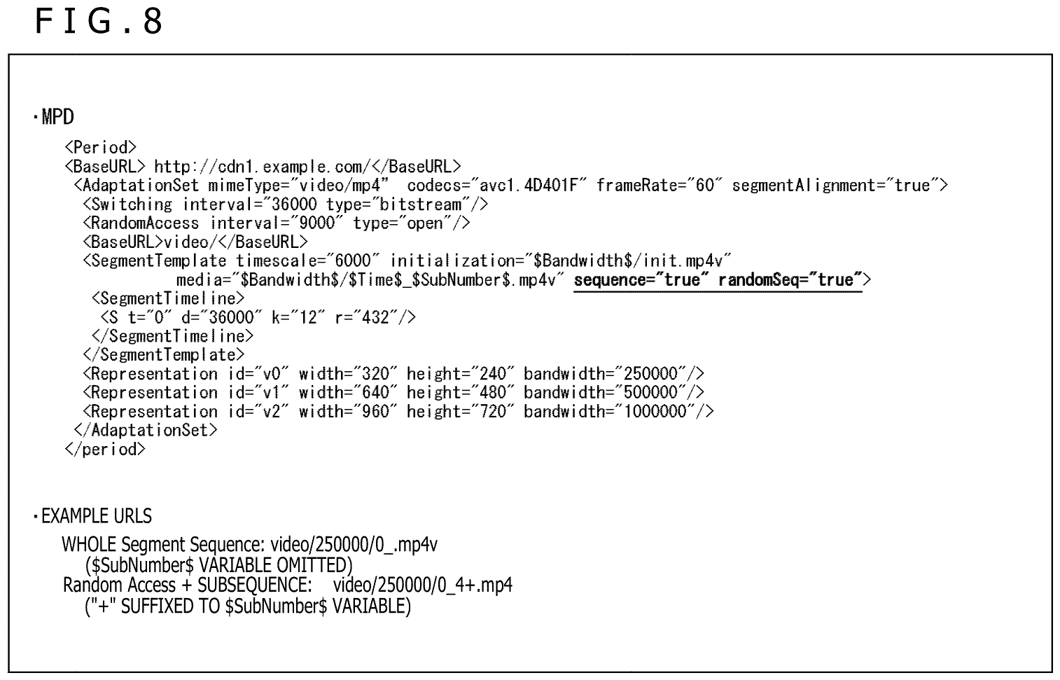

FIG. 8 illustrates an example of an MPD and URLs in a case where the initially described methods associated respectively with the first to third definition are applied.

As indicated in the MPD in FIG. 8, @sequence and @randomSeq described in the SegmentTemplate element is newly defined, and “true” is written to indicate that it is possible to respond to the respective requests.

Further, as indicated by the URL in FIG. 8, a definition is formed to add “+” to the end of the SubNumber variable in order to request a predetermined number of DASH segments from a random access point.

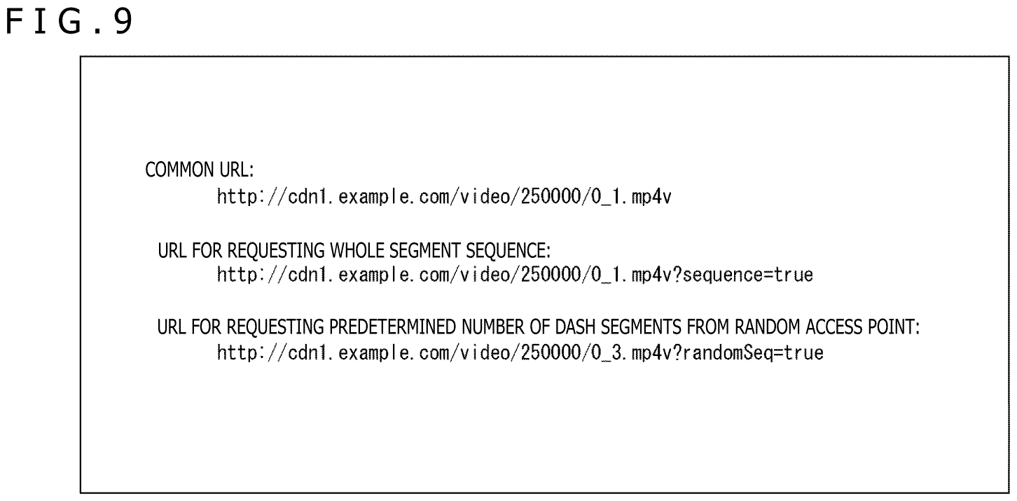

Moreover, FIG. 9 illustrates example of URLs conforming to the first and second definitions.

For example, it is possible to request the whole segment sequence and request a predetermined number of DASH segments from a random access point by using the depicted URL parameters to specify a URL that is different from a common URL depicted in FIG. 9.

Incidentally, even if the MPD indicates that segmentTemplate@sequence or segmentTemplate@randomSeq is “true,” it is possible that the delivery server 19 (e.g., edge server 16) receiving an actual request for DASH segments from the DASH client 17 may not support such a response. For example, in a case where a stream is delivered through the CDN, a part of the CDN edge server may not support the above function.

Consequently, whether or not the delivery server 19 from which the DASH client 17 actually acquires a content (DASH segments) is able to respond to a request for the whole segment sequence or a predetermined number of DASH segments from a random access point should preferably be confirmed beforehand.

More specifically, the DASH client 17 acquires and analyzes an MPD, then adds “DASH-request-sequence:” as an extension header to an HTTP request message for requesting Initialization Segment, and issues the resulting request. Either Sequence and RandomAccess or both of them are specified as the header value of the extension header.

In a case where the delivery server 19 supports a request for the whole segment sequence or a predetermined number of DASH segments from a random access point, the delivery server 19 returns a header indicating that such a request is supported. More specifically, in the above case, the delivery server 19 adds “DASH-accept-sequence:” as the extension header to the header of a response message for transmitting Initialization Segment, and specifies either Sequence and RandomAccess or both of them for the header value of the extension header in order to indicate one or more supported requests.

Consequently, only in a case where the extension header is added to a response from the delivery server 19 in order to indicate one or more supported requests, the DASH client 17 is able to request the whole segment sequence or a predetermined number of DASH segments from a random access point.

It should be noted that the above-mentioned extension header may be used when a Media Segment request is made subsequently to an Initialization Segment request. For optimal efficiency, however, the confirmation should be made when the Initialization Segment request is made.

FIG. 10 is a block diagram illustrating a configuration example of an embodiment of the delivery server and a DASH client to which the present technology is applied.

As depicted in FIG. 10, the delivery server 19 includes a request reception section 21, an acknowledgment section 22, and a DASH segment delivery section 23. The DASH client 17 includes a request transmission section 31, a support confirmation section 32, and a DASH segment acquisition section 33.

For example, depending on a data request (HTTP GET request) from the DASH client 17 to which a content is to be live-delivered, the delivery server 19 is able to deliver DASH segments included in the content. Meanwhile, the DASH client 17 is able to receive and analyze an MPD, then issue a request based on the URL of the DASH segments, and receive data (HTTP GET response) delivered corresponding to the request.

The request reception section 21 receives a request that is transmitted from the request transmission section 31 of the DASH client 17.

When the DASH client 17 confirms, by using the flag (extension header) defined as described above, whether or not the delivery server 19 supports a request for the whole segment sequence, the acknowledgment section 22 performs a process in response to the confirmation. Similarly, when the DASH client 17 confirms, by using the flag (extension header) defined as described above, whether or not the delivery server 19 supports a request for a predetermined number of DASH segments from a random access point, the acknowledgment section 22 performs a process in response to the confirmation.

Based on the URL specified by the request received by the request reception section 21, the DASH segment delivery section 23 delivers the dash segments included in the content. In this instance, in a case where a received HTTP GET request specifies the URL defined so as to request the whole segment sequence as depicted in FIGS. 8 and 9, the DASH segment delivery section 23 delivers the whole segment sequence corresponding to the received request. Meanwhile, in a case where the received HTTP GET request specifies the URL defined so as to request a predetermined number of DASH segments from a random access point as depicted in FIGS. 8 and 9, the DASH segment delivery section 23 delivers the predetermined number of DASH segments corresponding to the received request.

The request transmission section 31 references the MPD, and transmits a request for DASH segments included in the content to be live-delivered. For example, the request transmission section 31 is able to request the whole segment sequence specified by the SISSI extended function. Further, the request transmission section 31 is able to request a predetermined number of DASH segments including a random-accessible DASH segment and the subsequent DASH segments in the same segment sequence.

The support confirmation section 32 uses the above-defined flag (extension header) to confirm whether or not the delivery server 19 supports a request for the whole segment sequence. Similarly, the support confirmation section 32 uses the above-defined flag (extension header) to confirm whether or not the delivery server 19 supports a request for a predetermined number of DASH segments from a random access point.

Corresponding to the request transmitted from the request transmission section 31, the DASH segment acquisition section 33 acquires DASH segments delivered from the delivery server 19. That is, the DASH segment acquisition section 33 is able to acquire the whole segment sequence or a predetermined number of DASH segments from a random access point.

As the delivery server 19 and the DASH client 17 are configured as described above, using a URL defined so as to request the whole segment sequence makes it possible to sequentially deliver generated DASH segments without waiting until the complete generation of the whole segment sequence. Therefore, it is possible to reduce delay caused by a wait for the generation of the whole segment sequence, and thus provide live delivery with lower delay. Further, using the URL defined so as to request the whole segment sequence makes it possible to avoid the occurrence of a large number of HTTP requests and responses. This results in the avoidance of overhead.

Further, live delivery can be provided similarly with lower delay by allowing the delivery server 19 and the DASH client 17 to use a URL that is defined so as to request a predetermined number of DASH segments from a random access point. Moreover, in a case where an attempt is made to switch to different content (stream), the delivery of DASH segments included in the newly selected content can be started in a shorter wait time.

Further, the DASH client 17 is able to transmit a request after confirming whether or not the delivery server 19 supports such a URL-based delivery. Therefore, live delivery can be more certainly provided with lower delay.

For example, when the DASH client 17 issues a request for Initialization Segment to the delivery server 19, “DASH-request-sequence: Sequence RandomAccess” is added as the extension header as depicted in FIG. 10. Accordingly, in a case where the delivery server 19 supports a request for the whole segment sequence and a request for a predetermined number of DASH segments from a random access point, “DASH-accept-sequence: Sequence RandomAccess” is added as the extension header of the Initialization Segment.

When, as described above, the DASH client 17 confirms the support provided by the delivery server 19 and the delivery server 19 responds to the DASH client 17, live delivery can be certainly provided with lower delay.

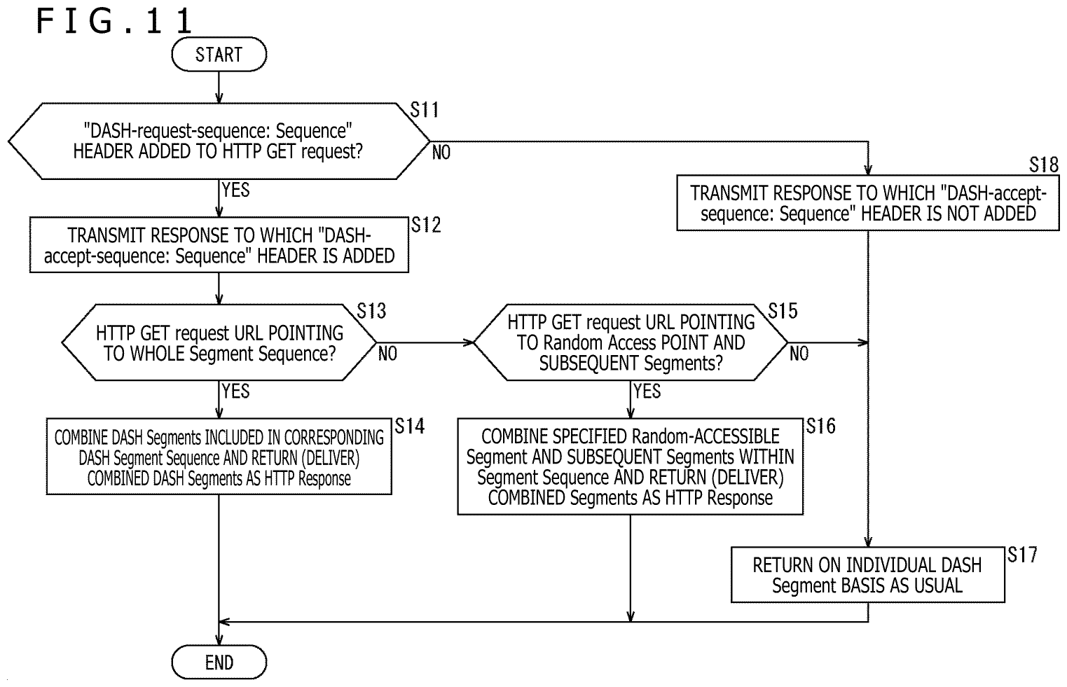

FIG. 11 is a flowchart illustrating a DASH segment delivery process that is performed by the delivery server 19 at the time of live delivery.

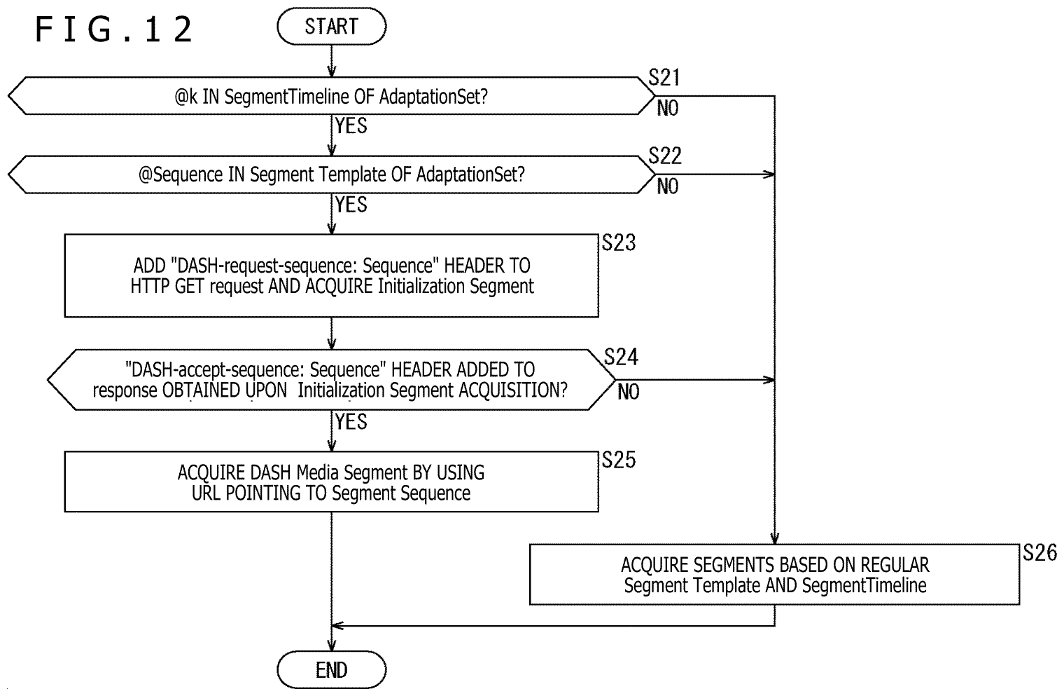

Processing starts when, for example, the request reception section 21 receives a request for Initialization Segment that is transmitted (later-described step S23 in FIG. 12) from the DASH client 17 at the beginning of DASH segment delivery. In step S11, the acknowledgment section 22 determines whether or not the “DASH-request-sequence: Sequence” extension header is added to the request (HTTP GET request) for Initialization Segment in order to indicate that requesting the whole segment sequence is supported.

In a case where it is determined in step S11 by the acknowledgment section 22 that the “DASH-request-sequence: Sequence” extension header is added, processing proceeds to step S12 as far as the delivery server 19 supports delivery that is provided by using a URL for requesting the whole segment sequence.

Depending on the result of confirmation made in step S11 by the acknowledgment section 22, the DASH segment delivery section 23 transmits, in step S12, as a response to the request from the DASH client 17, a response message to which a “DASH-accept-sequence: Sequence” extension header is added to reply that requesting the whole segment sequence is supported.

In step S13, the request reception section 21 determines whether or not the URL specified by the HTTP GET request points to the whole segment sequence.

In a case where it is determined in step S13 by the request reception section 21 that the URL specified by the HTTP GET request points to the whole segment sequence, processing proceeds to step S14. In step S14, the DASH segment delivery section 23 combines the DASH segments included in the requested segment sequence, and returns (delivers) the combined DASH segments as HTTP Response. Upon completion of step S14, processing terminates.

Meanwhile, in a case where it is determined in step S13 by the request reception section 21 that the URL specified by the HTTP GET request does not point to the whole segment sequence, processing proceeds to step S15. In step S15, the request reception section 21 determines whether or not the URL specified by the HTTP GET request points to a predetermined number of DASH segments from a random access point.

In a case where it is determined in step S15 by the request reception section 21 that the URL specified by the HTTP GET request points to a predetermined number of DASH segments from a random access point, processing proceeds to step S16. In step S16, the DASH segment delivery section 23 combines DASH segments including a specified random-accessible DASH segment and the subsequent DASH segments in the same segment sequence, and returns (delivers) the combined DASH segments as HTTP Response. Upon completion of step S16, processing terminates.

Meanwhile, in a case where it is determined in step S15 by the request reception section 21 that the URL specified by the HTTP GET request does not point to a predetermined number of DASH segments from a random access point, processing proceeds to step S17. In step S17, the DASH segment delivery section 23 performs a process of returning on an individual DASH segment basis as usual. Upon completion of step S17, processing terminates.

Incidentally, in a case where it is determined in step S11 by the acknowledgment section 22 that the “DASH-request-sequence: Sequence” extension header is not added, processing proceeds to step S18. Further, even if the “DASH-request-sequence: Sequence” extension header is added, processing proceeds to step S18 in a case where the delivery server 19 does not support delivery that is provided by using a URL for requesting the whole segment sequence.

Depending on the result of confirmation made in step S11 by the acknowledgment section 22, the DASH segment delivery section 23 transmits, in step S18, as a response to the request from the DASH client 17, a response message to which the “DASH-accept-sequence: Sequence” extension header is not added. Subsequently, processing proceeds to step S17 in order to perform the process of returning on an individual DASH segment basis as usual. Upon completion of step S17, processing terminates.

FIG. 12 is a flowchart illustrating a DASH segment acquisition process that is performed by the DASH client 17 at the time of live delivery.

Processing starts, for example, after the DASH client 17 acquires and analyzes an MPD. In step S21, the support confirmation section 32 determines whether or not the SegmentTimeline element of AdaptationSet described in the MPD has a value (@k) indicating the number of DASH segments included in a segment sequence.

In a case where it is determined in step S21 by the support confirmation section 32 that there is the value (@k) indicating the number of DASH segments included in the segment sequence, processing proceeds to step S22.

In step S22, the support confirmation section 32 determines whether or not the SegmentTemplate element of AdaptationSet described in the MPD has a flag (@sequence) indicating whether or not requesting the whole segment sequence is supported.

In a case where it is determined in step S22 by the support confirmation section 32 that there is the flag (@sequence) indicating whether or not requesting the whole segment sequence is supported, processing proceeds to step S23.

Depending on the result of confirmation made in steps S21 and S22 by the support confirmation section 32, the request transmission section 31 adds, in step S23, the “DASH-request-sequence: Sequence” extension header to the request (HTTP GET request) for Initialization Segment in order to confirm that requesting the whole segment sequence is supported, and then transmits the resulting request to the delivery server 19. Then, the DASH segment acquisition section 33 acquires Initialization Segment that is transmitted from the delivery server 19 corresponding to the request.

In step S24, the support confirmation section 32 confirms the response message received at the time of Initialization Segment acquisition in step S23, and determines whether or not the “DASH-accept-sequence: Sequence” extension header is added to reply that requesting the whole segment sequence is supported.

In a case where it is determined in step S24 by the support confirmation section 32 that the “DASH-accept-sequence: Sequence” extension header is added to the response message, processing proceeds to step S25. That is, in this case, the support confirmation section 32 is able to confirm that the delivery server 19 actually supports a request for the whole segment sequence.

In step S25, the request transmission section 31 issues a request for the whole segment sequence by using a URL, and the DASH segment acquisition section 33 acquires a segment sequence (a series of DASH segments) corresponding to the request.

Meanwhile, in a case where it is not determined in step S21 by the support confirmation section 32 that there is the value (@k) indicating the number of DASH segments included in the segment sequence, processing proceeds to step S26. Further, in a case where it is not determined in step S22 by the support confirmation section 32 that there is the flag (@sequence) indicating whether or not requesting the whole segment sequence is supported, processing proceeds to step S26. Similarly, in a case where it is not determined in step S24 by the support confirmation section 32 that the “DASH-accept-sequence: Sequence” extension header is added to the response message, processing proceeds to step S26. That is, in these cases, the support confirmation section 32 is able to confirm that the delivery server 19 does not actually support a request for the whole segment sequence.

In step S26, the request transmission section 31 transmits requests based on normal SegmentTemplate and SegmentTimeline, and the DASH segment acquisition section 33 acquires DASH segments depending on each of the requests.

Subsequently, when all the DASH segments necessary for live delivery are completely acquired in step S25 or S26, processing terminates.

When processing is performed as described above by the delivery server 19 and the DASH client 17, the DASH client 17 is able to confirm, before requesting a delivery of DASH segments, whether or not the delivery server 19 supports a request for the whole segment sequence. Therefore, for example, even if the MPD includes information regarding the value (@k) indicating the number of DASH segments included in a segment sequence or information regarding the flag (@sequence) indicating whether or not requesting the whole segment sequence is supported, the DASH client 17 is able to confirm whether or not support is provided by the delivery server 19, which actually requests the DASH segments. As a result, the delivery server 19 and the DASH client 17 are able to make a request for the whole segment sequence and provide live delivery with low delay.

It should be noted that, by performing similar processing, the DASH client 17 is able to confirm, before requesting a delivery of DASH segments, whether or not the delivery server 19 actually supports a request for a predetermined number of DASH segments from a random access point.

### <Configuration Example of Computer>

The above-described series of processes can be performed by hardware or by software. In a case where the series of processes is to be performed by software, a program included in the software is installed, for example, on a general-purpose computer.

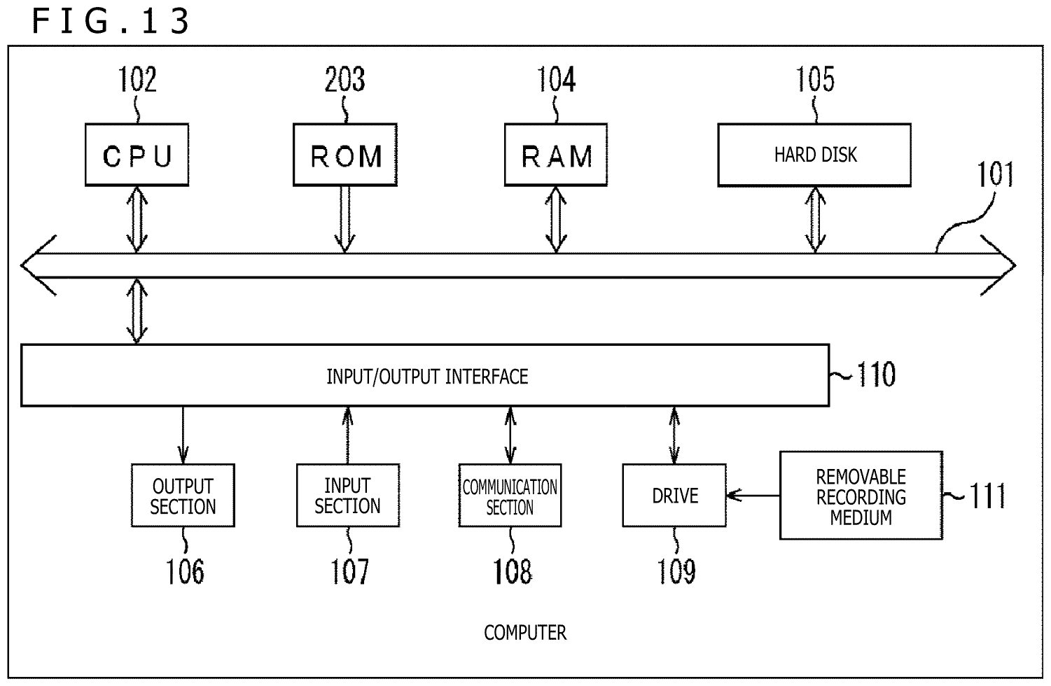

FIG. 13 is a block diagram illustrating a configuration example of an embodiment of the computer on which the program performing the above-described series of processes is to be installed.

The program may be pre-recorded on a hard disk 105, a ROM 103, or other recording medium built in the computer.

Alternatively, the program may be stored (recorded) on a removable recording medium 111 that driven by a drive 109. The removable recording medium 111 may be supplied as what is generally called package software. For example, a flexible disk, a CD-ROM (Compact Disc Read Only Memory), an MO (Magneto Optical) disk, a DVD (Digital Versatile Disc), a magnetic disk, or a semiconductor memory may be used as the removable recording medium 111.

It should be noted that the program may be not only installed on the computer from the above-described removable recording medium 111, but also downloaded into the computer from a communication network or a broadcast network and installed on the built-in hard disk 105. More specifically, the program may be, for example, wirelessly transferred from a download site to the computer through an artificial satellite for digital satellite broadcasting or wiredly transferred to the computer through a network such as a LAN (Local Area Network) or the Internet.

The computer incorporates a CPU (Central Processing Unit) 102. The CPU 102 is connected to an input/output interface 110 through a bus 101.

When, for example, a user operates an input section 107 to input a command to the CPU 102 through the input/output interface 110, the CPU 102 executes the program stored in the ROM (Read Only Memory) 103 in accordance with the command. Alternatively, the CPU 102 loads the program stored on the hard disk 105 into a RAM (Random Access Memory) 104 and executes the program.

Accordingly, the CPU 102 performs processing according to the above-described flowcharts or the configurations depicted in the above-described block diagrams. Then, as needed, the CPU 102, for example, causes an output section 106 to output the result of processing through the input/output interface 110 or causes a communication section 108 to transmit the result of processing through the input/output interface 110, and then causes the hard disk 105 to record the result of processing.

It should be noted that the input section 107 includes, for example, a keyboard, a mouse, and a microphone, and that the output section 106 includes, for example, an LCD (Liquid Crystal Display) and a speaker.

Here, the processes to be performed by the computer in accordance with the program as described in the present specification need not always be performed in a chronological order described in a flowchart. That is, the processes to be performed by the computer in accordance with the program include processes that are performed parallelly or individually (e.g., parallel processes or object-based processes).

Further, the program may be processed by a single computer (processor) or distributively processed by a plurality of computers. Moreover, the program may be transferred to and executed by a remote computer.

Further, the term “system,” which is used in the present specification, refers to an aggregate of a plurality of component elements (e.g., apparatuses and modules (parts)), and is applicable no matter whether or not all the component elements are within the same housing. Therefore, the term “system” may refer not only to a plurality of apparatuses accommodated in separate housings and connected through a network, but also to a single apparatus including a plurality of modules accommodated in a single housing.

Further, for example, a configuration described as the configuration of a single apparatus (or processing section) may be divided and configured as the configuration of a plurality of apparatuses (or processing sections). Conversely, a configuration described earlier as the configuration of a plurality of apparatuses (or processing sections) may be configured as the configuration of a single apparatus (or processing section). Moreover, a configuration other than those described earlier may be added to the configuration of each apparatus (or each processing section). Additionally, a part of the configuration of an apparatus (or a processing section) may be included in the configuration of another apparatus (or another processing section) as far as the overall system configuration and operation remain unchanged.

Further, the present technology may be configured, for example, for crowd computing in which one function is shared by a plurality of apparatuses through a network in order to perform processing in a collaborative manner.

Further, for example, the above-mentioned program may be executed by any apparatus. In such a case, the apparatus executing the program should incorporate necessary functions (functional blocks, etc.) and be able to acquire necessary information.

Further, for example, each step described with reference to the foregoing flowcharts may be not only performed by a single apparatus but also performed in a shared manner by a plurality of apparatuses. Moreover, in a case where a plurality of processes is included in a single step, the plurality of processes included in such a single step may be not only performed by a single apparatus but also performed in a shared manner by a plurality of apparatuses. Stated differently, a plurality of processes included in a single step may be performed as processes in a plurality of steps. Conversely, processing described as processing performed in a plurality of steps may be performed in a single step.

It should be noted that the program to be executed by the computer may perform processing steps descriptive of the program in a chronological order described in the present specification or perform the processing steps in a parallel manner or individually at a necessary time point in response, for example, to a program call. That is, the individual processing steps may be performed in an order different from the above-described order as far as no inconsistency occurs. Further, the processing steps descriptive of the program may be performed in parallel or in combination with processing performed by another program.

It should be noted that a plurality of aspects of the present technology described in the present specification may be implemented independently on an individual basis as far as no inconsistency occurs. It is obvious that any plurality of aspects of the present technology may be implemented together. For example, the whole or part of the present technology described in conjunction with any of the foregoing embodiments may be implemented in combination with the whole or part of the present technology described in conjunction with another embodiment. Further, any part or the whole of the present technology described above may be implemented together with another technology not described above.

### <Example Combinations of Configurations>

It should be noted that the present technology may adopt the following configurations as well.

(1)

A delivery apparatus including:

a reception section that receives a request from a client regarded as a destination to which a content is live-delivered by using MPEG-DASH (Dynamic Adaptive Streaming over HTTP); and

a delivery section that delivers DASH segments included in the content based on a URL (Uniform Resource Locator) specified by the request,

in which, in a case where an extended function of independently specifying a duration of the DASH segments and a placement of an SAP (Stream Access Point) is used to define the URL so as to make a request for a whole of a segment sequence including a series of the DASH segments consecutively arranged, the delivery section delivers the whole of the segment sequence corresponding to the request.

(2)

The delivery apparatus as described in (1) above,

in which, in a case where the URL is defined so as to make a request for a predetermined number of the DASH segments from a random access point, including a random-accessible DASH segment and subsequent DASH segments in the same segment sequence, the delivery section delivers the predetermined number of the DASH segments corresponding to the request.

(3)

The delivery apparatus as described in (2) above, further including:

an acknowledgment section that makes a response to a confirmation that is made from the client through the use of a flag, the flag being defined to indicate whether or not a request for the whole of the segment sequence is supported or whether or not a request for the predetermined number of the DASH segments from the random access point is supported, the acknowledgment section.

(4)

The delivery apparatus as described in (3) above,

in which the request for the whole of the segment sequence is made after the response indicating the support for requesting the whole of the segment sequence is confirmed by the client through the use of the flag.

(5)

The delivery apparatus as described in (3) above,

in which the request for the predetermined number of the DASH segments from the random access point is made after the response indicating the support for requesting the predetermined number of the DASH segments from the random access point is confirmed by the client through the use of the flag.

(6)

A delivery method including the steps of:

by a delivery apparatus providing live delivery by using MPEG-DASH (Dynamic Adaptive Streaming over HTTP),

receiving a request from a client regarded as a destination to which a content is live-delivered; and

delivering DASH segments included in the content based on a URL (Uniform Resource Locator) specified by the request,

in which, in a case where an extended function of independently specifying a duration of the DASH segments and a placement of an SAP (Stream Access Point) is used to define the URL so as to make a request for a whole of a segment sequence including a series of the DASH segments consecutively arranged, the whole of the segment sequence corresponding to the request is delivered.

(7)

A program for causing a computer in a delivery apparatus providing live delivery by using MPEG-DASH (Dynamic Adaptive Streaming over HTTP) to perform a process including the steps of:

receiving a request from a client regarded as a destination to which a content is live-delivered; and

delivering DASH segments included in the content based on a URL (Uniform Resource Locator) specified by the request,

in which, in a case where an extended function of independently specifying a duration of the DASH segments and a placement of an SAP (Stream Access Point) is used to define the URL so as to make a request for a whole of a segment sequence including a series of the DASH segments consecutively arranged, the program causes the computer to deliver the whole of the segment sequence corresponding to the request.

(8)

A reception apparatus including:

a transmission section that transmits, to a delivery apparatus, a request for a content live-delivered by using MPEG-DASH (Dynamic Adaptive Streaming over HTTP); and

a reception section that receives DASH segments included in the content delivered based on a URL (Uniform Resource Locator) specified by the request,

in which, in a case where an extended function of independently specifying a duration of the DASH segments and a placement of an SAP (Stream Access Point) is used to define the URL so as to make a request for a whole of a segment sequence including a series of the DASH segments consecutively arranged, the reception section receives the whole of the segment sequence that is delivered corresponding to the request.

(9)

The reception apparatus as described in (8) above,

in which, in a case where the URL is defined so as to make a request for a predetermined number of the DASH segments from a random access point, including a random-accessible DASH segment and subsequent DASH segments in the same segment sequence, the reception section receives the predetermined number of the DASH segments corresponding to the request.

(10)

The reception apparatus as described in (9) above, further including:

a support confirmation section that uses a flag to confirm the support provided by the delivery apparatus, the flag being defined to indicate whether or not a request for the whole of the segment sequence is supported or whether or not a request for the predetermined number of the DASH segments from the random access point is supported.

(11)

The reception apparatus as described in (10) above,

in which the transmission section transmits a request for the whole of the segment sequence after a response received from the delivery apparatus indicating the support for requesting the whole of the segment sequence is confirmed through the use of the flag.

(12)

The reception apparatus as described in (10) above,

in which the transmission section transmits a request for the predetermined number of the DASH segments from the random access point after a response received from the delivery apparatus indicating the support for requesting the predetermined number of the DASH segments from the random access point is confirmed through the use of the flag.

(13)

A reception method including the steps of:

by a reception apparatus receiving a content live-delivered by using MPEG-DASH (Dynamic Adaptive Streaming over HTTP),

transmitting a request for the content to a delivery apparatus; and

receiving DASH segments included in the content delivered based on a URL (Uniform Resource Locator) specified by the request,

in which, in a case where an extended function of independently specifying a duration of the DASH segments and a placement of an SAP (Stream Access Point) is used to define the URL so as to make a request for a whole of a segment sequence including a series of the DASH segments consecutively arranged, the whole of the segment sequence delivered corresponding to the request is received.

(14)

A program for causing a computer in a reception apparatus receiving a content live-delivered by using MPEG-DASH (Dynamic Adaptive Streaming over HTTP) to perform a process including the steps of:

transmitting a request for the content to a delivery apparatus; and

receiving DASH segments included in the content delivered based on a URL (Uniform Resource Locator) specified by the request,

in which, in a case where an extended function of independently specifying a duration of the DASH segments and a placement of an SAP (Stream Access Point) is used to define the URL so as to make a request for a whole of a segment sequence including a series of the DASH segments consecutively arranged, the program causes the computer to receive the whole of the segment sequence delivered corresponding to the request.

It should be noted that the embodiments of the present disclosure are not limited to the embodiments described above, and may be modified variously without departing from the scope and spirit of the present disclosure. Further, the advantages described in the present specification are merely illustrative and not restrictive. The present disclosure may additionally provide advantages other than those described in the present specification.

### REFERENCE SIGNS LIST

11 Live-delivery system, 12 Encoder, 13 DASH segment generation section, 14 DASH server, 15 Intermediate server, 16 Edge server, 17 DASH client, 18 CDN, 19 Delivery server, 21 Request reception section, 22 Acknowledgment section, 23 DASH segment delivery section, 31 Request transmission section, 32 Support confirmation section, 33 DASH segment acquisition section

1. A delivery apparatus comprising:
a reception section that receives a request from a client regarded as a destination to which a content is live-delivered by using MPEG-DASH (Dynamic Adaptive Streaming over HTTP); and
a delivery section that delivers DASH segments included in the content based on a URL (Uniform Resource Locator) specified by the request,
wherein, in a case where an extended function of independently specifying a duration of the DASH segments and a placement of an SAP (Stream Access Point) is used to define the URL so as to make a request for a whole of a segment sequence including a series of the DASH segments consecutively arranged, the delivery section delivers the whole of the segment sequence corresponding to the request.

2. The delivery apparatus according to claim 1,
wherein, in a case where the URL is defined so as to make a request for a predetermined number of the DASH segments from a random access point, including a random-accessible DASH segment and subsequent DASH segments in a same segment sequence, the delivery section delivers the predetermined number of the DASH segments corresponding to the request.

3. The delivery apparatus according to claim 2, further comprising:
an acknowledgment section that makes a response to a confirmation that is made from the client through the use of a flag, the flag being defined to indicate whether or not a request for the whole of the segment sequence is supported or whether or not a request for the predetermined number of the DASH segments from the random access point is supported.

4. The delivery apparatus according to claim 3,
wherein the request for the whole of the segment sequence is made after the response indicating the support for requesting the whole of the segment sequence is confirmed by the client through the use of the flag.

5. The delivery apparatus according to claim 3,
wherein the request for the predetermined number of the DASH segments from the random access point is made after the response indicating the support for requesting the predetermined number of the DASH segments from the random access point is confirmed by the client through the use of the flag.

6. A delivery method comprising the steps of:
by a delivery apparatus providing live delivery by using MPEG-DASH (Dynamic Adaptive Streaming over HTTP),
receiving a request from a client regarded as a destination to which a content is live-delivered; and
delivering DASH segments included in the content based on a URL (Uniform Resource Locator) specified by the request,
wherein, in a case where an extended function of independently specifying a duration of the DASH segments and a placement of an SAP (Stream Access Point) is used to define the URL so as to make a request for a whole of a segment sequence including a series of the DASH segments consecutively arranged, the whole of the segment sequence corresponding to the request is delivered.

7. A program for causing a computer in a delivery apparatus providing live delivery by using MPEG-DASH (Dynamic Adaptive Streaming over HTTP) to perform a process including the steps of:
receiving a request from a client regarded as a destination to which a content is live-delivered; and
delivering DASH segments included in the content based on a URL (Uniform Resource Locator) specified by the request,
wherein, in a case where an extended function of independently specifying a duration of the DASH segments and a placement of an SAP (Stream Access Point) is used to define the URL so as to make a request for a whole of a segment sequence including a series of the DASH segments consecutively arranged, the program causes the computer to deliver the whole of the segment sequence corresponding to the request.
